(19) United States
(12) Patent Application Publication
(10) Pub. No.: US 2020/0238726 A1
(43) Pub. Date: Jul. 30, 2020

(54) IMAGE FORMING APPARATUS

(71) Applicant: KYOCERA Document Solutions Inc., Osaka (JP)

(72) Inventor: Masayuki Miyake, Osaka (JP)

(73) Assignee: KYOCERA Document Solutions

(21) Appl. No.: 16/746,315

(22) Filed: Jan. 17, 2020

(30) Foreign Application Priority Data
Jan. 24, 2019 (JP) 2019-010083

(51) Int. Cl. B41J 2/21; G06F 3/12

(52) U.S. Cl. CPC B41J 2/2132; G06F 3/1256

(57) ABSTRACT

In an image forming apparatus, a control unit controls a print engine and a sheet transportation unit. If on-sheet preliminary ink ejection is not prohibited as preliminary ink ejection for the print engine, the control unit performs preliminary ink ejection onto a print sheet on which a user-specified image is printed, and if on-sheet preliminary ink ejection is prohibited as preliminary ink ejection for the print engine, the control unit performs preliminary ink ejection onto another print sheet than the print sheet on which a user-specified image is printed. Further, the control unit controls the sheet transportation unit and thereby outputs a print sheet on which a user-specified image is printed to a first sheet outputting unit among the plural sheet outputting units, and outputs the another print sheet to a second sheet outputting unit other than the first sheet outputting unit among the plural sheet outputting units.

### CROSS-REFERENCE TO RELATED APPLICATIONS

This application relates to and claims priority rights from Japanese Patent Application No. 2019-010083, filed on Jan. 24, 2019, the entire disclosures of which are hereby incorporated by reference herein.

### BACKGROUND

### 1. Field of the Present Disclosure

The present disclosure relates to an image forming apparatus.

### 2. Description of the Related Art

An inkjet-type image forming apparatus performs on-sheet preliminary ink ejection in order to restrain a trouble such as precision deterioration of an ink droplet hitting position and/or ink density deterioration with regard to a nozzle that ejects no ink during predetermined time. The on-sheet preliminary ink ejection is preliminary ink ejection performed (a) when an image specified by a user is printed and (b) on a paper sheet on which the image is printed.

However, the on-sheet preliminary ink ejection is not favorable for a user who requires high image quality of a printed matter because, as mentioned, the on-sheet preliminary ink ejection forms a small dot unassociated with the image specified by a user on the paper sheet on which the image is printed. Therefore, such a user causes the apparatus to perform a purge action rather than the on-sheet preliminary ink ejection.

In a line-head-type inkjet image forming apparatus, a head is fixed, and therefore, for the purge action, a transportation belt opposite to the head is removed and an ink tray is moved to an under side of the head, and thereafter, a pump or the like applies high ink pressure and thereby ejects ink from a nozzle.

Thus, the purge action requires mechanically removing the transportation belt and mechanically moving the ink tray, and consequently, a long-time interruption occurs in a print job and therefore, it is inconvenient for a user.

### SUMMARY

An image forming apparatus according to an aspect of the present disclosure includes a print engine, a sheet transportation unit, plural sheet outputting units, and a control unit. The print engine is configured to print an image to be printed on a print sheet in an inkjet manner. The sheet transportation unit is configured to transport the print sheet. The plural sheet outputting units are selectable as an output destination of the print sheet on which printing has been finished in the print engine. The control unit is configured to control the print engine and the sheet transportation unit. Further, (a) if on-sheet preliminary ink ejection is not prohibited as preliminary ink ejection for the print engine, the control unit performs preliminary ink ejection onto a print sheet on which a user-specified image is printed, and (b) if on-sheet preliminary ink ejection is prohibited as preliminary ink ejection for the print engine, the control unit performs preliminary ink ejection onto another print sheet than the print sheet on which a user-specified image is printed. Furthermore, the control unit controls the sheet transportation unit and thereby (a) outputs a print sheet on which a user-specified image is printed to a first sheet outputting unit among the plural sheet outputting units, and (b) outputs the another print sheet to a second sheet outputting unit other than the first sheet outputting unit among the plural sheet outputting units.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of the image forming apparatus shown in FIG. 1;

FIG. 3 shows a block diagram that indicates an electronic configuration of the image forming apparatus 10 in the embodiment according to the present disclosure;

FIG. 4 shows a diagram that indicates examples of a quality maintenance sheet after a print process; and

FIG. 5 shows a flowchart that explains a behavior of the image forming apparatus 10 shown in FIG. 1.

### DETAILED DESCRIPTION

Hereinafter, an embodiment according to an aspect of the present disclosure will be explained with reference to drawings.

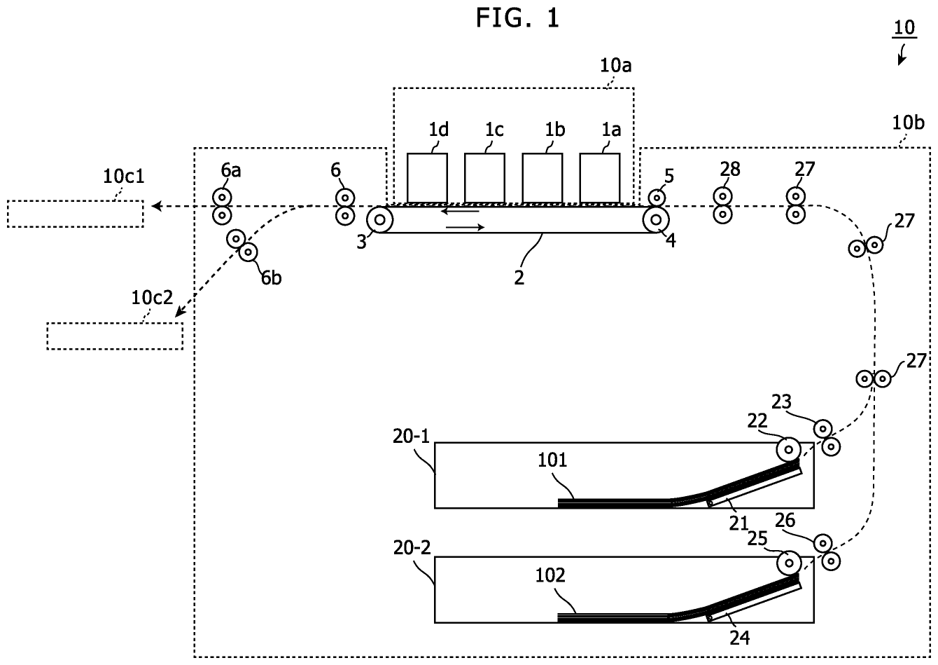

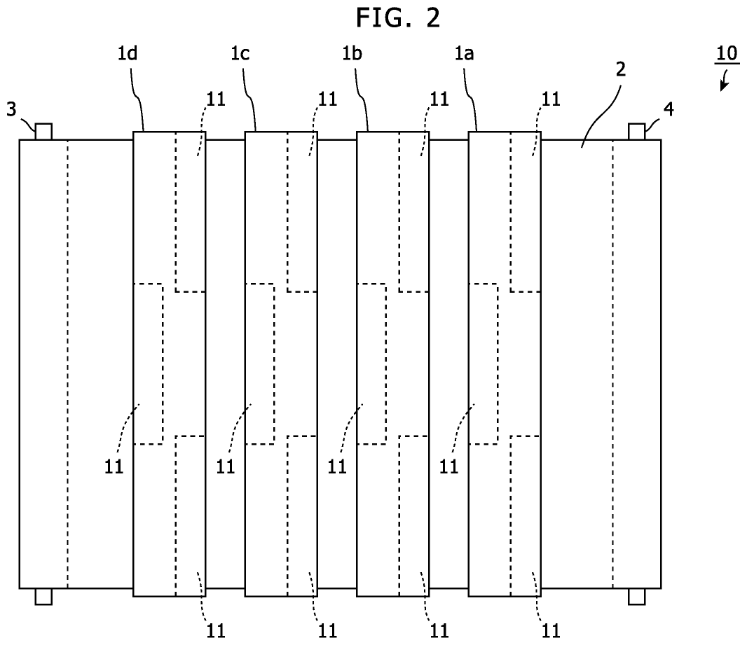

FIG. 1 shows a side view that indicates an internal mechanical configuration of an image forming apparatus in an embodiment according to the present disclosure. FIG. 2 shows a plane view of the image forming apparatus shown in FIG. 1.

The image forming apparatus 10 in this embodiment is an apparatus such as printer, copier, facsimile machine or multi function peripheral, and includes an inkjet color printing mechanism of a line head type in this embodiment.

The image forming apparatus 10 includes a print engine 10a and a sheet transportation unit 10b. The print engine 10a physically prints an image to be printed on a print sheet (print paper sheet or the like). The sheet transportation unit 10b transports the print sheet to the print engine 10a.

In this embodiment, the print engine 10a includes line-head-type inkjet recording units 1a to 1d corresponding to four ink colors: Cyan, Magenta, Yellow, and Black.

As shown in FIG. 2, in this embodiment, each inkjet recording unit 1a, 1b, 1c or 1d includes plural (here, three) head units 11. The head units 11 are arranged along a primary scanning direction, and are capable of being mounted to and demounted from a main body of the image forming apparatus. Each inkjet recording unit 1a, 1b, 1c or 1d may include only one head unit 11.

Further, in this embodiment, the sheet transportation unit 10b includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6, 6a, and 6b.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the printing, the print sheet is outputted by the output roller pairs 6, 6a, and 6b to an output tray 10c1 or 10c2 or the like.

This image forming apparatus includes at least two output trays 10c1 and 10c2, and after the printing, the print sheet is outputted to the first output tray 10c1 by the output roller pair 6a or outputted to the second output tray 10c2 by the output roller pair 6b.

Further, the sheet transportation unit 10b includes plural sheet feeding cassettes 20-1 and 20-2. The sheet feeding cassettes 20-1 and 20-2 store print sheets 101 and 102, and push up the print sheets 101 and 102 using lift plates 21 and 24 so as to cause the print sheets 101 and 102 to contact with pickup rollers 22 and 25, respectively. The print sheets 101 and 102 put on the sheet feeding cassettes 20-1 and 20-2 are picked up to sheet feeding rollers 23 and 26 by the pickup rollers 22 and 25 sheet by sheet from the upper side, respectively. The sheet feeding rollers 23 and 26 are rollers that transport the print sheets 101 and 102 sheet by sheet fed by the pickup rollers 22 and 25 from the sheet feeding cassettes 20-1 and 20-2 onto a transportation path.

A transportation roller 27 is a transportation roller on the transportation path common to the print sheets 101 and 102 transported from the sheet feeding cassettes 20-1 and 20-2.

The registration roller 28 temporarily stops the incoming print sheet 101 or 102 in transportation, and transports this print sheet 101 or 102 to the print engine 10a at a secondary sheet feeding timing. The secondary sheet feeding timing is instructed by a control unit 81 mentioned below such that an image is formed at a specified position on the print sheet 101 or 102.

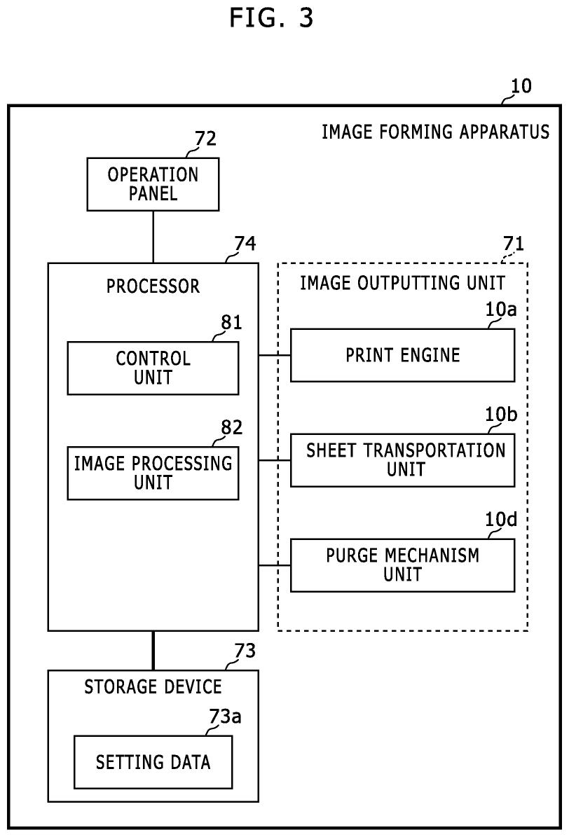

FIG. 3 shows a block diagram that indicates an electronic configuration of the image forming apparatus 10 in the embodiment according to the present disclosure.

As shown in FIG. 3, the image forming apparatus 10 includes not only an image outputting unit 71 that includes the mechanical configuration shown in FIGS. 1 and 2 but an operation panel 72, a processor 73, and a processor 74.

In this embodiment, the image outputting unit 71 includes a purge mechanism unit 10d that performs a purge action for the head units 11 of the print engine 10a. Specifically, the purge mechanism unit 10d includes an ink tray (not shown) and a driving unit that moves the transportation belt 2 and the ink tray (not shown), and when performing a purge action of the head units 11, performs (a) removement of the transportation belt 2 and the like and movement of the ink tray (not shown) before starting the purge action and (b) movement of the transportation belt 2 and the like and removement of the ink tray (not shown) after ending the purge action.

The operation panel 72 is arranged on a housing surface of the image forming apparatus 10, and includes a display device such as a liquid crystal display and an input device such as a hard key and/or touch panel, and displays sorts of messages for a user using the display device and receives a user operation using the input device.

The storage device 73 is a non-volatile storage device (flash memory, hard disk drive or the like) in which data, a program and the like have been stored and are required for control of the image forming apparatus 10. In the storage device 73, setting data 73a mentioned below has been stored.

The processor 74 includes a computer that acts in accordance with a program, an ASIC (Application Specific Integrated Circuit) that performs a predetermined action, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required).

Here the processor 74 acts as a control unit 81 and an image processing unit 82.

The control unit 81 controls the image outputting unit (the print engine 10a, the sheet transportation unit 10b and the like), and thereby performs a print job requested by a user. In this embodiment, the control unit 81 causes the image processing unit 82 to perform a predetermined image process, and controls the head units 11 and causes the head units 11 to eject ink and thereby forms a printing image on a print sheet. The image processing unit 82 performs a predetermined image process such as RIP (Raster Image Processing), color conversion, halftoning and/or the like for image data of a printing image.

In particular, (a) if on-sheet preliminary ink ejection is not prohibited as preliminary ink ejection for the print engine 10a, the control unit 81 performs preliminary ink ejection onto a print sheet on which a user-specified image (hereinafter, also called “user image sheet”) is printed, and (b) if on-sheet preliminary ink ejection is prohibited as preliminary ink ejection for the print engine 10a, the control unit 81 performs preliminary ink ejection onto another print sheet than the print sheet on which a user-specified image is printed (hereinafter, also called “quality maintenance sheet”).

It should be noted that “preliminary ink ejection” is an action that ejects ink for a maintenance purpose rather than for an image forming purpose with a nozzle of the head units 11 that has not been used during a predetermined time or in predetermined printed pages. Further “on-sheet preliminary ink ejection” is preliminary ink ejection performed onto a user image sheet.

The output trays 10c1 and 10c2 are used as plural sheet outputting units selectable as an output destination of the print sheet on which printing has been finished in the print engine 10a; and the control unit 81 controls the sheet transportation unit 10b and thereby (a) outputs the user image sheet to the output tray 10c1 among the output trays 10c1 and 10c2 and (b) outputs the quality maintenance sheet to the output tray 10c2 among the output trays 10c1 and 10c2.

Further, in this embodiment, if on-sheet preliminary ink ejection is prohibited as preliminary ink ejection for the print engine, the control unit 81 controls the sheet transportation unit 10b and thereby transports as the quality maintenance sheet a print sheet of another sheet type than the user image sheet.

For example, the sheet feeding cassettes 20-1 and 20-2 store print sheets of different types from each other; and a print sheet stored in the sheet feeding cassette 20-1 is used as the user image sheet, and a print sheet stored in the sheet feeding cassette 20-2 is used as the quality maintenance sheet. It should be noted that a print sheet used as the quality maintenance sheet may have a lower quality and/or a lower price than a print sheet used as the user image sheet.

Further, the setting data 73a includes preliminary ink ejection setting data, quality maintenance sheet output setting data, quality maintenance sheet type setting data, and the like. The preliminary ink ejection setting data specifies whether or not on-sheet preliminary ink ejection is allowed as preliminary ink ejection for the print engine 10a. The quality maintenance sheet output setting data specifies an output destination of the quality maintenance sheet. The quality maintenance sheet type setting data specifies a type of a print sheet (or its sheet feeding cassette) used as the quality maintenance sheet. This setting data 73a is editable on the basis of a user operation to the operation panel 72.

The control unit 81 (a) determines whether on-sheet preliminary ink ejection is prohibited as preliminary ink ejection for the print engine 10a or not on the basis of the preliminary ink ejection setting data, (b) selects an output tray as an output destination of the quality maintenance sheet on the basis of the quality maintenance sheet output setting data, and (c) selects a type of a print sheet used as the quality maintenance sheet or its sheet feeding cassette on the basis of the quality maintenance sheet type setting data.

If on-sheet preliminary ink ejection is prohibited as preliminary ink ejection for the print engine 10a, the control unit 81 performs preliminary ink ejection onto the quality maintenance sheet while a print job is performed, without performing the purge action while performing a print job. For example, if maintenance of the head units 11 should be performed every 1,000 sheets in a print job for printing of 10,000 sheets, preliminary ink ejection is performed onto the quality maintenance without performing the purge action due to a relatively long time required for the purge action.

Further, in this embodiment, the print engine 10a is a color print engine that uses ink of plural ink colors; and if on-sheet preliminary ink ejection is prohibited for a partial ink color among the plural ink colors and is not prohibited for a remaining ink color other than the partial ink color among the plural ink colors, the control unit 81 (a) for the partial ink color, performs preliminary ink ejection onto the quality maintenance sheet and (b) for the remaining ink color, performs preliminary ink ejection onto the user image sheet.

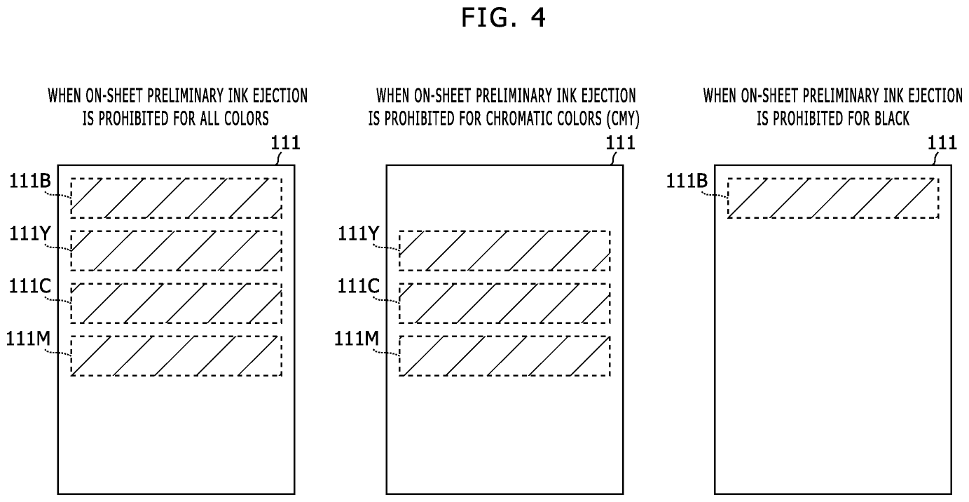

FIG. 4 shows a diagram that indicates examples of a quality maintenance sheet after a print process.

In this embodiment, the preliminary ink ejection setting data includes (a) a first setting item that indicates whether on-sheet preliminary ink ejection is allowed of black ink or not and (b) a second setting item that indicates whether on-sheet preliminary ink ejection is allowed of chromatic ink colors (here cyan, magenta, yellow, i.e. CMY) or not.

Therefore, if on-sheet preliminary ink ejection is prohibited on both of the first and second setting items, then as shown in FIG. 4, preliminary ink ejection of black ink 111B and chromatic color ink 111C, 111M, and 1111Y is performed onto the quality maintenance sheet 111. Further, if on-sheet preliminary ink ejection is prohibited on the second setting item but is allowed on the first setting item, then as shown in FIG. 4, preliminary ink ejection of black ink 111B is not performed onto the quality maintenance sheet 111, but preliminary ink ejection of chromatic color ink 111C, 111M, and 1111Y is performed onto the quality maintenance sheet 111. Furthermore, if on-sheet preliminary ink ejection is prohibited on the first setting item but is allowed on the second setting item, then as shown in FIG. 4, preliminary ink ejection of chromatic color ink 111C, 111M, and 1111Y is not performed onto the quality maintenance sheet 111, but preliminary ink ejection of black ink 111B is performed onto the quality maintenance sheet 111.

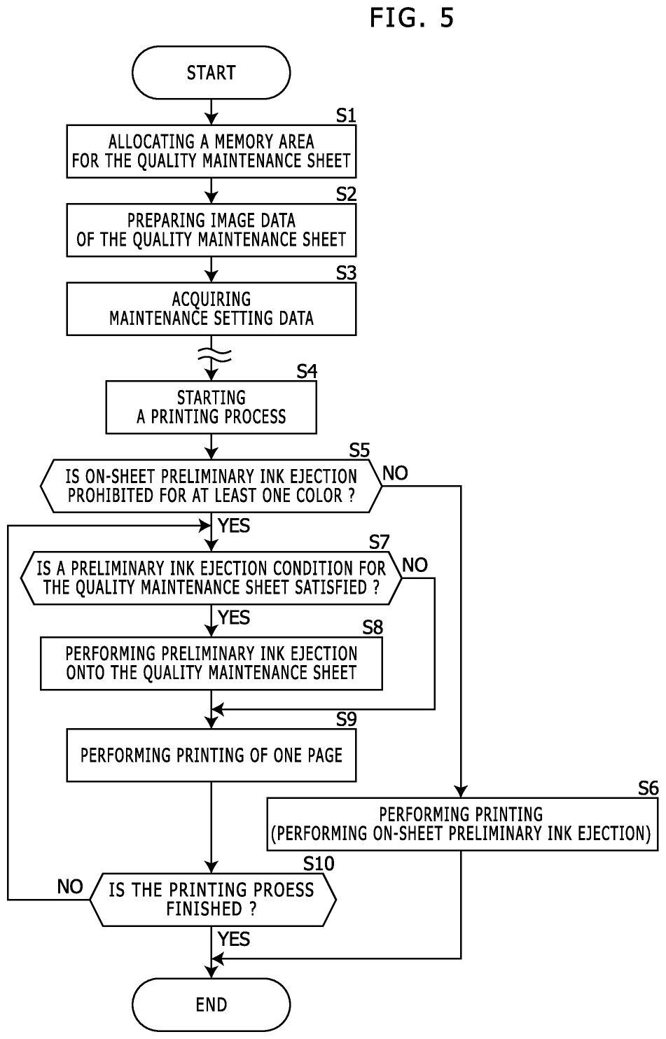

The following part explains a behavior of the image forming apparatus 10. FIG. 5 shows a flowchart that explains a behavior of the image forming apparatus 10 shown in FIG. 1.

When starting the image forming apparatus 10, the control unit 81 allocates a memory area of a size required for the quality maintenance sheet in the RAM of the processor 74 (in Step S1), and stores and prepares image data of the quality maintenance sheet in this memory area (in Step S2). Further, the control unit 81 reads the setting data 73a from the storage device 73 (in Step S3).

Afterward, when receiving a job request based on a user operation to the operation panel 72 or receiving a job request from a user's host device using a communication device (not shown), the control unit 81 performs the requested printing process using the image outputting unit 71. When starting the printing process (in Step S4), the control unit 81 determines whether on-sheet preliminary ink ejection is prohibited for at least one ink color or not on the basis of the setting data 73a (in Step S5).

If on-sheet preliminary ink ejection is not prohibited for any ink colors, then the control unit 81 using the image outputting unit 71, performs printing of an image specified by the job request on the user image sheet, and also performs on-sheet preliminary ink ejection if required (in Step S6). For this process, the control unit 81 causes the sheet transportation unit 10b to transport a print sheet from the predetermined sheet feeding cassette 20-1 (i.e. the user image sheet) to the print engine 10a, and to transport the user image sheet outputted from the print engine 10a to the predetermined output tray 10c1.

Contrarily, if on-sheet preliminary ink ejection is prohibited for at least one ink color, then the control unit 81 determines whether a preliminary ink ejection condition for the quality maintenance sheet is satisfied or not (in Step S7). For example, this preliminary ink ejection condition is (a) that a current time point is before starting the printing process (i.e. right before printing of the first page), (b) that the number of printed pages after a previous preliminary ink ejection reaches a predetermined value, or the like. Here, the number of printed pages after a previous preliminary ink ejection is counted by the controller 81; and the counted value is stored in the non-volatile storage device 73 and reset to zero when preliminary ink ejection is performed onto the quality maintenance sheet. In addition, this counted value is reset also when the purge action is performed.

If the preliminary ink ejection condition is satisfied, the control unit 81 performs preliminary ink ejection onto the quality maintenance sheet for an ink color specified by the setting data 73a (in Step S8). For this process, the control unit 81 controls the sheet transportation unit 10b and thereby mechanically performs switching the transportation path, and causes the sheet transportation unit 10b to transport a print sheet from the predetermined sheet feeding cassette 20-2 (i.e. the quality maintenance sheet) to the print engine 10a, and to transport the user image sheet outputted from the print engine 10a to the predetermined output tray 10c2.

It should be noted that the preliminary ink ejection onto the quality maintenance sheet requires time for switching the transportation path, transporting the quality maintenance sheet and the like, but this time is shorter than time required for the purge action.

Subsequently, the control unit 81 performs printing an image of one page (i.e. the first page or a subsequent page) in the printing process using the image outputting unit 71 (in Step S9). In this process, on-sheet preliminary ink ejection is performed for an ink color for which on-sheet preliminary ink ejection is allowed, if required.

Subsequently, the control unit 81 determines whether the printing process is finished or not (in Step S10); and if the printing process is not finished, the control unit 81 returns to Step S7 and performs the processes in and after Step S7, until the printing process is finished.

As mentioned, in the aforementioned embodiment, the print engine 10a prints an image to be printed on a print sheet in an inkjet manner, and the sheet transportation unit 10b transports the print sheet. The plural sheet outputting units 10c1 and 10c2 are selectable as an output destination of the print sheet on which printing has been finished in the print engine 10a. The control unit 81 controls the print engine 10a and the sheet transportation unit 10b. Further, (a) if on-sheet preliminary ink ejection is not prohibited as preliminary ink ejection for the print engine 10a, the control unit 81 performs preliminary ink ejection onto a print sheet on which a user-specified image is printed (i.e. onto the user image sheet), and (b) if on-sheet preliminary ink ejection is prohibited as preliminary ink ejection for the print engine 10a, the control unit 81 performs preliminary ink ejection onto another print sheet than the print sheet on which a user-specified image is printed (i.e. onto the quality maintenance sheet). Furthermore, the control unit 81 controls the sheet transportation unit 10b and thereby (a) outputs a print sheet on which a user-specified image is printed (i.e. the user image sheet) to a first sheet outputting unit among the plural sheet outputting units 10c1 and 10c2, and (b) outputs the aforementioned another print sheet (i.e. the quality maintenance sheet) to a second sheet outputting unit other than the first sheet outputting unit among the plural sheet outputting units 10c1 and 10c2.

Consequently, the preliminary ink ejection is performed so as to restrain deterioration on usability and image quality.

In particular, the quality maintenance sheet is outputted to an output tray other than an output tray to which the user image sheet is outputted, and therefore, the quality maintenance sheet is not lost in lots of the user image sheets.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a print engine configured to print an image to be printed on a print sheet in an inkjet manner;
a sheet transportation unit configured to transport the print sheet;
plural sheet outputting units selectable as an output destination of the print sheet on which printing has been finished in the print engine; and
a control unit configured to control the print engine and the sheet transportation unit;
wherein (a) if on-sheet preliminary ink ejection is not prohibited as preliminary ink ejection for the print engine, the control unit performs preliminary ink ejection onto a print sheet on which a user-specified image is printed, and (b) if on-sheet preliminary ink ejection is prohibited as preliminary ink ejection for the print engine, the control unit performs preliminary ink ejection onto another print sheet than the print sheet on which a user-specified image is printed; and
the control unit controls the sheet transportation unit and thereby (a) outputs a print sheet on which a user-specified image is printed to a first sheet outputting unit among the plural sheet outputting units, and (b) outputs the another print sheet to a second sheet outputting unit other than the first sheet outputting unit among the plural sheet outputting units.

2. The image forming apparatus according to claim 1, wherein if on-sheet preliminary ink ejection is prohibited as preliminary ink ejection for the print engine, the control unit controls the sheet transportation unit and thereby transports as the another print sheet to the print engine a print sheet of another sheet type than a sheet type of a print sheet on which a user-specified image is printed.

3. The image forming apparatus according to claim 1, further comprising a purge mechanism unit configured to perform a purge action for a head of the print engine;
wherein if on-sheet preliminary ink ejection is prohibited as preliminary ink ejection for the print engine, the control unit performs preliminary ink ejection onto the another print sheet without performing the purge action while performing a print job.

4. The image forming apparatus according to claim 1, wherein
the print engine is a color print engine that uses ink of plural ink colors; and
if on-sheet preliminary ink ejection is prohibited for a partial ink color among the plural ink colors and is not prohibited for a remaining ink color other than the partial ink color among the plural ink colors, the control unit (a) for the partial ink color, performs preliminary ink ejection onto the another print sheet and (b) for the remaining ink color, performs preliminary ink ejection onto a print sheet on which a user-specified image is printed.
